(19) United States
(12) Patent Application Publication
(10) Pub. No.: US 2026/0037645 A1
(43) Pub. Date: Feb. 5, 2026

(54) DATA SYNCHRONIZATION TOOL BETWEEN DESKTOP APPLICATION AND WEB-BASED APPLICATION

(71) Applicant: Fourlane, Austin, TX (US)

(72) Inventors: Marjorie Adams, Austin, TX (US); William Edward Hilton, Nolensville, TN (US)

(21) Appl. No.: 19/014,403

(22) Filed: Jan. 9, 2025

Related U.S. Application Data
(60) Provisional application No. 63/677,682, filed on Jul. 31, 2024.

(51) Int. Cl. G06F 21/60

(52) U.S. Cl. CPC G06F 21/602

(57) ABSTRACT

The document generally describes systems and methods that include determining, at a cloud service layer executing on a remote computing system, a set of synchronization work to be handled by a sync client executing on a local computing system based on a last modified time of a cloud-based database; adding, by the cloud service layer, at least one synchronization action to a work stack to be handled by the sync client based on actions performed on the cloud-based database, wherein the at least one synchronization action includes at least one record pointer to source records; compressing and encrypting the work stack and transmitting the work stack from the cloud service layer to the sync client; decompressing and decrypting, by the sync client, the work stack; and sending, by the sync client, the decompressed and decrypted work stack to an SDK of a local application.

### CROSS-REFERENCE TO RELATED APPLICATION

This application claims the benefit of U.S. Provisional Application No. 63/677,682, filed Jul. 31, 2024, and titled “Intelligent Tool for Data Synchronization Between Desktop Accounting Application and Web-Based Third-Party Application,” which is incorporated by reference.

### TECHNICAL FIELD

This document relates to computer systems, media, and methods for enabling lightweight, low-friction synchronization between a desktop-based application and a web-based database or application.

### BACKGROUND

Conventional accounting software is designed to automate financial transactions and record-keeping processes. It can streamline tasks such as creating invoices, tracking expenses, managing payroll, and generating financial reports. This software can range from simple, basic tools suitable for small businesses to complex, enterprise-level solutions capable of handling large-scale operations.

### SUMMARY

Some embodiments herein include computer systems, media and methods that include determining, at a cloud service layer executing on a remote computing system, a set of synchronization work to be handled by a sync client executing on a local computing system based on a last modified time of a cloud-based database; adding, by the cloud service layer, at least one synchronization action to a work stack to be handled by the sync client based on actions performed on the cloud-based database, wherein the at least one synchronization action includes at least one record pointer to source records; compressing and encrypting the work stack and transmitting the work stack from the cloud service layer to the sync client; decompressing and decrypting, by the sync client, the work stack; and sending, by the sync client, the decompressed and decrypted work stack to an SDK of a local application.

In some instances, the methods and systems further include receiving a response package from the SDK at the sync client; compressing and encrypting the response package; and transmitting the encrypted and compressed response package to the cloud service layer. In some instances, this also includes transmitting an end of work signal from the sync client to the cloud service layer, wherein the end of work signal is different than the response package. in response to receiving the end of work signal: decompressing and decrypting, by the cloud service layer, the response package; and writing results of the response package to the cloud-based database.

In some instances, the response package comprises at least one update to the cloud-based database based on a change to a database managed by the local application.

In some instances, the at least one synchronization action includes an add request, or a modification request, to change a database managed by the local application in order to synchronize the database managed by the local application with the cloud-based database. In some instances, the set of synchronization work comprises a parent synchronization action and a child synchronization action, wherein the child synchronization action is dependent on completion of the parent synchronization action, the method or operations can further include:
adding, by the cloud service layer, the parent synchronization action to the work stack; and
responsive to receiving a response package indicating successful completion of the parent synchronization, queuing the child synchronization action to be added to a future work stack.

In some instances, transmitting the work stack from the cloud service layer to the sync client is scheduled to occur periodically at a predetermined interval. In some instances, the predetermined interval is ten seconds.

In some instances, the local application is QuickBooks®.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a simplified system diagram showing a system for low-friction synchronization between a local application and a remote database layer.

FIG. 2 is a flowchart illustrating an example process for synchronization.

FIG. 3 is a workflow diagram illustrating an example process for synchronization.

FIG. 4 is an example graphical user interface for performing synchronization between a local application and a remote database layer.

FIG. 5 is a flowchart illustrating an example process for synchronization.

Like reference symbols in the various drawings indicate like elements.

### DETAILED DESCRIPTION OF ILLUSTRATIVE EMBODIMENTS

The present solution relates to an innovation in synchronization technology for a third-party cloud-based application working in conjunction with an executing desktop application. Synchronizations from the cloud-based application to the desktop application are performed in an time-based manner, for example, every 10 seconds, while synchronizations from the desktop application to the cloud-based application are performed in a time-based and/or periodic manner. In some implementations, synchronizations occur every 10 minutes. In some instances, the desktop application may be Intuit's QuickBooks® product, although any suitable desktop application may be used.

The solution provides significant speed improvements over conventional sync clients. Conventional sync clients for QuickBooks®, for example, may update slowly, or may operate on a five (5) minute increment. Further, synchronization operations can slow down desktop applications when the data is being transmitted without significant cadence of event planning. The proposed solution solves for both the speed and slowdown issues experienced in existing solutions. Compared to traditional sync client solutions, the methods described herein can reduce client time by 300-500%, depending on the request size.

A push and pull of data between a desktop application's desktop SDK and a web-based application are used to provide the synchronization. The web-based application uses, or is associated with, a custom web service that defines the data to be synced and the schedule upon which to perform the sync. The data is cached into the web service, and processing and the cached data can be performed after the sync is completed.

The synchronization from the desktop application to the sync application is performed generally as follows. First, the desktop application data is cached and compressed outside of the desktop application and stored in the cloud database, thereby allowing the solution to manage and be in control of the flow. Many existing solutions for synchronization do not use a separate cache and compressing of data-instead, in those solutions a constant checking and confirming of the desktop application's database data is required to manage and receive the updates. For example, existing solutions ask “Does Customer Exist?” The present solution states: “Customer exists” and so does not need to confirm the existence of the customer. By using a separate cache, the present solution can minimize communications and workload for the local system by requesting only when new information is required. Beyond the initial sync, the present solution requests modified data in all requests from the desktop data, thereby improving the speed of the synchronization.

From the sync client to the desktop application, requests are defined by the web service and are pushed at regular intervals (e.g., every 10 seconds, every minute, or other interval). The actions can be dependent on the appropriate flow for what is required to occur. For example, data is sent in the first 10 seconds to a new customer, and transactions are performed in the second 10 seconds. This provides faster synchronization for the solution, as the verification of data occurs in a cached warehouse of data outside of the desktop application. This is in contrast to existing solutions, where the desktop application is checked or pinged continuously for every new data set to verify that data does not already exist or that the data is valid.

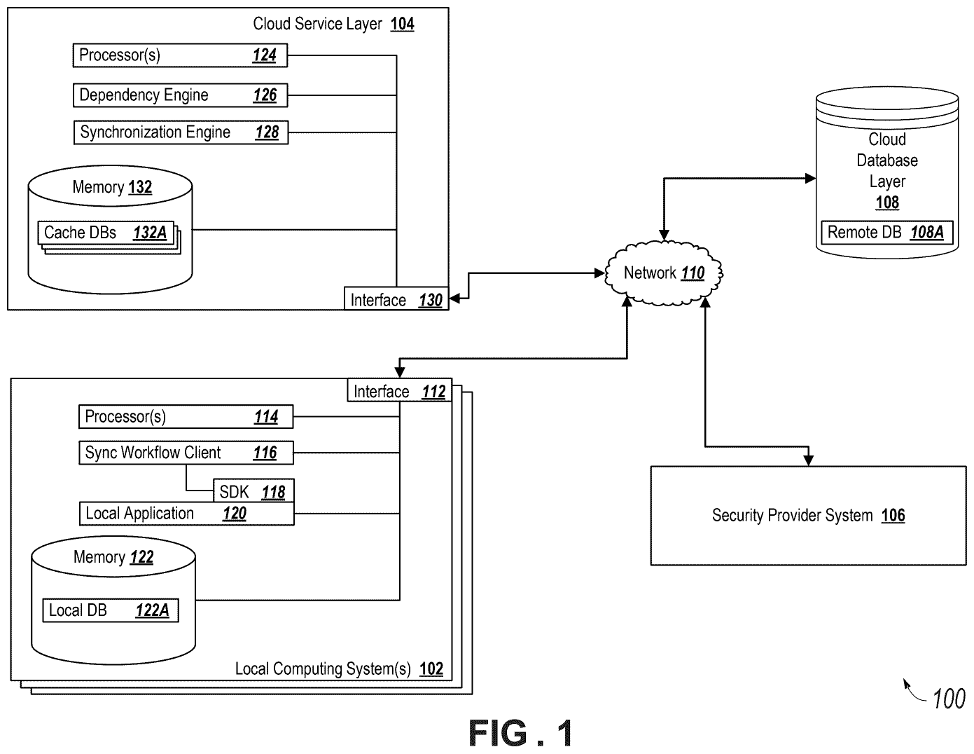

Turning to FIG. 1, a simplified system diagram showing a system 100 for low-friction synchronization between a local application and a remote database layer is illustrated. The system 100 includes a local computing system 102, a cloud service layer 104, a security provider system 106, and a cloud database layer 108. These systems and layers are coupled together using a network 110 which enables communications between them.

Network 110 facilitates wireless or wireline communications between the components of the system 100 (e.g., between the local computing system 102, the cloud service layer 104, and/or the database layer 108 etc.), as well as with any other local or remote computers, such as additional mobile devices, clients, servers, or other devices communicably coupled to network 110, including those not illustrated in FIG. 1. In the illustrated environment, the network 110 is depicted as a single network, but can include more than one network without departing from the scope of this disclosure, so long as at least a portion of the network 110 can facilitate communications between senders and recipients. In some instances, one or more of the illustrated components (e.g., memory 132, dependency engine 126, etc.) can be included within or deployed to network 110, or a portion thereof, as one or more cloud-based services or operations. The network 110 can be all or a portion of an enterprise or secured network, while in another instance, at least a portion of the network 110 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-networks, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

Local computing system 102 can be a desktop computer, laptop computer, tablet, or other device that is generally operated by a user and executes the local application 120. The local computing system 102 includes an interface 112, memory 122, one or more processors 114, a sync workflow client 116, and a local application 120 which includes a software development kit (SDK) 118. As shown in FIG. 1, multiple local computing systems 102 can each independently execute and interact with the system 100. Each local computing system 102 can independently maintain a local database 122A and require synchronization with the remote database 108A.

The interface 112 is used by the local computing system 102 for communicating with other systems in a distributed environment-including within the system 100—connected to the network 110, including cloud service layer 104, the security provider system 106, and other systems communicably coupled to the local computing system 102 and/or network 110. Generally, the interface 112 comprises logic encoded in software and/or hardware in a suitable combination and operable to communicate with the network 110 and other components. More specifically, the interface 112 can comprise software supporting one or more communication protocols associated with communications such that the network 110 and/or interface's hardware is operable to communicate physical signals within and outside of the illustrated system 100. Still further, the interface 112 can allow the local computing system 102 to communicate with the cloud service layer 104 and/or the security provider system 106 and other systems to perform the operations described herein.

Memory 122 of the local computing system 102 can represent a single memory or multiple memories. The memory 122 can include any memory or database module and can take the form of volatile or non-volatile memory including, without limitation, magnetic media, optical media, random access memory (RAM), read-only memory (ROM), removable media, or any other suitable local or remote memory component. The memory 122 can store various objects or data, including accounting data, user and/or account information, administrative settings, password information, caches, applications, backup data, repositories storing business and/or dynamic information, and any other appropriate information associated with the local computing system 102, including any parameters, variables, algorithms, instructions, rules, constraints, or references thereto. Additionally, the memory 122 can store any other appropriate data, such as VPN applications, firmware logs and policies, firewall policies, a security or access log, print or other reporting files, as well as others. While illustrated within the local computing system 102, memory 122 or any portion thereof, including some or all of the particular illustrated components, can be located, in some instances, remote from the local computing system 102 in some instances, including as a cloud application or repository, or as a separate cloud application or repository. In some examples, the data stored in memory 122 can be accessible, for example, via network 110, and can be obtained by particular applications or functionality of the Cloud service layer 104.

The local computing system 102 also includes one or more processors 114. Although illustrated as a single processor 114 in FIG. 1, multiple processors can be used according to particular needs, desires, or particular implementations of the system 100. Each processor 114 can be a central processing unit (CPU), an application specific integrated circuit (ASIC), a field-programmable gate array (FPGA), or another suitable component. Generally, the processor 114 executes instructions and manipulates data to perform the operations of the local computing system 102. Specifically, the processor 114 executes the algorithms and operations described in the illustrated figures, as well as the various software modules and functionality, including the functionality for sending communications to and receiving transmissions from the cloud service layer 104, as well as to other devices and systems. Each processor 114 can have a single or multiple core, with each core available to host and execute an individual processing thread. Further, the number of, types of, and particular processors 114 used to execute the operations described herein can be dynamically determined based on a number of requests, interactions, and operations associated with the local computing system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

The local application 120 can be an application executing on the local computing system 102 that generally enables users to perform accounting operations such as generation of invoices, tracking of transactions or expenses, payroll management, financial reporting, and tax preparation. An example of a local application 120 is Intuit QuickBooks®. The local application 120 can operate and maintain a local database 122A, which can include tables, objects, rulesets and other elements for operating the local application 120. In general, a user can use the local application 120 to access information and manipulate data within the local database 122A. However, shared databases, collaborative actions, and multi-user/multi-system environments require the local database 122A to be synchronized with remote repositories, such as remote database 108A, which is stored within the database layer 108.

The local application 120 can include an SDK 118 which can permit third-party software, such as the sync workflow client 116, to interact with the local database 122A through the local application 120. The SDK 118 can represent a set of libraries, functions, and API's that enable other applications such as the sync workflow client 116 to utilize the capabilities of the local application 120.

In some instances, the sync workflow client 116 is a thin program that executes on the local computing system 102 and enables the cloud service layer 104 to automatically synchronize the local database 122A with the remote database 108B while using a minimal consumption of resources at the local computing system 102. In general, the sync workflow client 116 can send and receive requests and work stacks from the cloud service layer 104 and the security provider system 106. Additionally, the sync workflow client 116 can compress, decompress, encrypt, and decrypt data as necessary to ensure secure communications with systems external to the local computing system 102. In some implementations, the sync workflow client 116 receives instructions or work stacks from the cloud service layer 104, processes them by decompressing and decrypting them, and sends them to the SDK 118 for operation by the local application 120. When the local application finishes processing the work stack and provides a return or response package, the sync workflow client 116 can generate a return package by compressing and encrypting the return, as well as adding additional material (e.g., pointers, timestamps, metadata etc.) and formatting the return for transmission to the cloud service layer 104. In some implementations, the sync workflow client 116 sends a request with credentials to the security provider system 106 and receives a security token, which the client 116 includes with communications to the cloud service layer 104 to enable the cloud service layer 104 to authenticate the sync workflow client 116. In some implementations, the security token is time-limited, and both the sync workflow client 116 and the cloud service layer 104 periodically request or receive new tokens from the security provider system 106, as needed.

The security provider system 106 can be a third-party or external authentication service that enables registration and provides secure authentication of users/access. In general, the security provider system 106 authorizes users (or applications) by generating an access token that is unique to that application and providing the token upon authentication. For example, the cloud service layer 104 can require authentication by the security provider system 106 to provide access. The cloud service layer 104 can indicate to the security provider system 106 that the local computing system 102 or sync workflow client 116 is an authorized user. Then, when the sync workflow client 116 provides proper credentials to the security provider system 106, the security provider system 106 can send an access token to the sync workflow client 116. The access token can be sent with (e.g., attached to, embedded in, etc.) communications to the cloud service layer 104, which can verify that the sender of the access token has been authenticated by the security provider system 106. In some implementations, the security provider system 106 uses an open authorization (OAuth) protocol and is provided as an external service. In some implementations, the cloud service layer 104 provides its own internal authentication and security (e.g., issues its own access tokens).

Cloud service layer 104 can be a remote or cloud-based system such as a virtual machine or container in a virtual environment. In some implementations, the cloud service layer 104 can be executed in a cloud environment that includes at least one server and at least one data store. In some instances, the cloud environment can be represented or include various forms of servers including, but not limited to, a web server, an application server, a proxy server, a network server, and/or a server pool, as well as individual processing elements or resources of similar machines. In general, server systems accept requests for application services and provides such services to any number of client devices (e.g., the client 116 over the network 110). In accordance with implementations of the present disclosure, and as noted above, the cloud environment can host applications and databases running on host infrastructure. In some instances, the cloud environment can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

In general, the cloud service layer 104 provides the logic and intelligence required to maintain local database 122A synchronized with remote database 108A for multiple local computing systems 102. The cloud service layer 104 can include or be associated with one or more processors 124, which can be similar to or different from processors 114. Cloud service layer 104 communicates within system 100 via network 110 using interface 130, which can be similar to or different from interface 112. In some implementations, the cloud service layer 104 includes a memory 132, which can be similar to or different from memory 122 and includes cached local databases 132A.

The synchronization engine 128 generally monitors and tracks changes to the cloud database layer 108 and remote database 108A. The synchronization engine 128 generates and sends work stacks to the sync workflow client(s) 116 of each registered local computing system 102. In some instances, a timer can trigger a synchronization with a known periodicity to ensure that the local databases 122A are maintained in a synchronized state with the remote database 108A. When the synchronization is triggered, the synchronization engine 128 can retrieve any changes from the remote database 108A that have a timestamp relatively newer than the previous synchronization, and compile them into a work stack. The work stack is then sent to the sync workflow client 116 for writing into the local databases 122A. In some instances, the work stack is stored in memory 132 temporarily while the local computing system(s) 102 are processing. In some instances, the return package will include changes to the local database 122A that need to be written to the remote database 108A. The synchronization engine 128 can perform the updates by communicating with the cloud database layer 108 according to the received return package. In some implementations, the cloud database layer 108 and the cloud service layer 104 are both instantiated in shared computing environment (e.g., on a shared virtual machine). The cloud database layer 108 and the cloud service layer 104 can communicate via a local network using database communication protocols.

A dependency engine 126 can identify and structure dependencies in the work stacks generated by the synchronization engine 128. The dependency engine 126 can maintain a state or cache database 132A for each local database 122A, which enables the cloud service layer 104 and dependency engine 126 to understand the current state of the local databases 122A without accessing it. The cached databases 132A maintained at the cloud service layer 104 prevent the cloud service layer 104 from requiring additional communications and operations at the local computing system 102. The sync workflow client 116 can be configured to not make any calls into the local application 120 or grab data from the local database 122A until it has established access to the cloud service layer 104. This ensures no additional data need be stored on the local computing system 102.

If a work stack generated by the synchronization engine 128 includes a task that is dependent on the completion of another task, the dependency engine 126 can ensure they are sent to the local computing system 102 in logical order, and only when confirmation is received that the first task or parent task is complete. For example, when a work stack includes the task of generating a new column in a table and a second task to change a value within that column, the local computing system 102 will need to receive and execute the task of generating the column first. The dependency engine 126 can recognize this dependency and withhold the column update task (child task) from the work stack. The work stack is then sent to the local computing system 102 without the child task, and upon receipt of a return package indicating the column generation task (parent task) is complete, the dependency engine 126 can release the column updating task (child task) into the work stack.

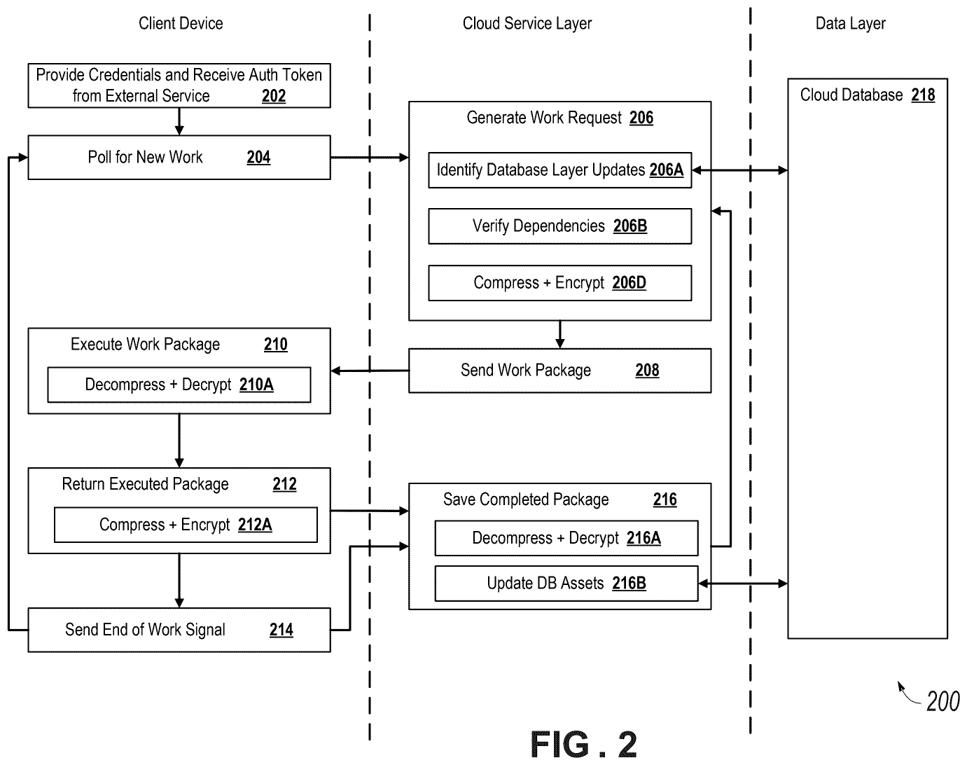

FIG. 2 is a flowchart illustrating an example process for synchronization. FIG. 2 is an example method illustrated from the point of view of a local computing system and cloud service layer, such as local computing system 102 and cloud service layer 104 of FIG. 1. However, it will be understood that process 200 may be performed, for example, by any other suitable system, environment, software, and hardware, or a combination of systems, environments, software, and hardware as appropriate. Process 200 may be performed by a plurality of connected components or systems. Any suitable system(s), architecture(s), or application(s) can be used to perform the illustrated operations.

At 202, the client device (e.g., local computing device 102 of FIG. 1) can provide credentials and receive an authorization or access token from an external service. In some implementations, the external service is an OAUTH provider such as Amazon Web Services, Azure, Symantec, Duo, or other provider.

At 204, during an initial setup, the client device can send a message, including the client device's current database state and the authorization token to the cloud service layer. This poll for new work can indicate that the client device is online and ready to begin synchronizing its local database with the cloud database in the data layer. In some implementations, the poll occurs each time the client device is logged in, reboots, or recommences operations following a timeout. In some instances, the poll occurs on a routine basis (e.g., when a watchdog timer expires). In some implementations, once initial handshaking is complete, synchronization described in 200 continually repeats unless it is paused manually.

At 206, the cloud service layer generates a work request. The work request can be a set of tasks to be completed at the client device in order to place the local database at the client device in a state matching the cloud database. The cloud service layer can identify database layer updates (206A) that are changes to the cloud database since the previous synchronization. In some implementations, each change to the cloud database is recorded in a changelog with a timestamp, and the database layer updates are identified by selecting updates with timestamps newer than the previous synchronization. Upon generation of an initial work stack, each task can be analyzed to verify whether there are dependent tasks (206B). In some implementations, at this point of initial sync the cloud service layer starts tracking changes. In some implementations, some certain tasks cannot be completed until other tasks are completed. These dependent tasks can be withheld until the next synchronization period, when the prior task has been completed. Some tasks may be overridden by later tasks, for example, a table element can be updated, and then updated again. In some instances, the overridden task can be removed from the work stack, leaving only the latest update. Once the work request is generated, it is compressed to conserve network bandwidth, and encrypted to ensure security (206D). Compression can be performed, for example, using an LZ77 algorithm, the DEFLATE algorithm, Lempel-Ziv Markov chain algorithm (LZMA), or other algorithms. Encryption can be any suitable encryption method, such as JSON web encryption (JWE), Advanced Encryption Standard (AES), Rivest-Shamir-Adelman (RSA) encryption, or other algorithms. In some implementations, the encryption is an asymmetric encryption that uses the access token of the client device.

At 208, the work package is transmitted to the client device via a network or other suitable connection. In some implementations, a dedicated synchronization application such as the sync workflow client 116 of FIG. 1 receives the work package for processing at the client device.

At 210, the work package is executed at the client device. The work package can be decompressed and decrypted (210A) by a thin local client, which then sends the work package to an SDK associated with a local application managing the local database. The local application executes the tasks in the work package and generates a return.

At 212, the executed work package is returned to the cloud service layer. The executed return package can indicate tasks completed, as well as include an error log indicating which tasks were not completed or only partially completed. Additionally, the executed work package can include objects or assets to be updated in the cloud database. In some implementations, at 212, the client device can request and update its access token with the external service. Similarly, the cloud service layer can receive or update its access token. For example, the access token can be set to expire hourly. In those instances, a new access token will be generated each hour, and the client device will be re-authenticated with a new access token. The client device can compress and encrypt the executed work package (212) then send to the cloud service layer.

At 214, separately from returning the executed work package, an end of work signal is generated and sent by the client device to the cloud service following the executed work package.

At 216, after receiving both the executed package and the end of work signal, the cloud service layer can decompress and decrypt the executed work package (216A), then update the cloud database (218) and the associated assets (216B). By waiting for the separate end of work signal, to begin processing and updating the cloud database, the cloud system, and synchronization application executing on the client device minimizes interactions with the SDK of the local applications or accounting application, and therefore minimizes the computational cost of performing synchronization. In other words, the SDK is not called until the cloud server indicates it is ready to receive data.

An example process in FIG. 2 is described above. Other processes fall within the scope of the appended claims. In some situations, the actions or steps described in the claims can be implemented in an order different from the order in the examples and the desired results can still be achieved. In addition, the process depicted in the accompanying drawings does not necessarily need a particular execution order to achieve the desired results. In some implementations, multi-tasking and concurrent processing are feasible or can be advantageous.

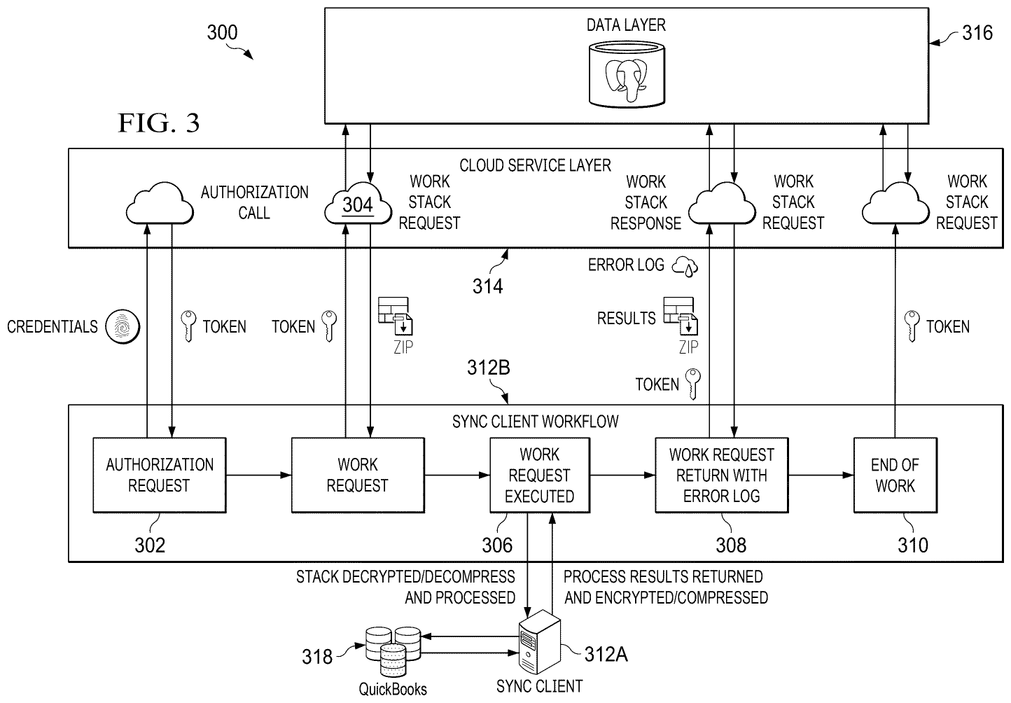

FIG. 3 is a workflow diagram illustrating an example process for synchronization. FIG. 3 provides an illustration of an example implementation of the described solution 300. As illustrated, a desktop application, identified as QuickBooks 318, is associated with a sync client component 312A. The illustrated solution shows the executing of data transfer as managed by the sync client 312A and the desktop application 318, allowing different types of synchronization in different directions.

As shown, the sync client component syncs the data between the desktop application and an external database. Any third-party or external products or tools that use or access the desktop application's data could access the sync client to perform synchronizations and updates. The sync client can be installed or available on the user's system where they access the desktop application. In some instances, this location could be in a hosted server (e.g., Skyline or RightWorks), or alternatively, on the user's own local computer. In some instances, the sync client has two components: (1) a local desktop installation 312B (e.g., the sync client workflow 116 described in FIG. 1) and a cloud component 314 (e.g., the cloud service layer 104 of FIG. 1) that executes on a remote cloud server and updates or interacts with a data layer 316.

As shown by 302, the sync client workflow 312B and the cloud service layer 314 perform authentication. As described, authentication is based on OAuth2, although any suitable authentication protocols and techniques may be used in other instances. In some instances, a token can be provided after authentication is confirmed, where the token may be valid for a period of time (e.g., 1 hour) prior to expiration. In the illustrated example, any encryption/decryption activities use issued tokens to perform the encryption/decryption actions. Other methods of authentication may also be used in alternative implementations.

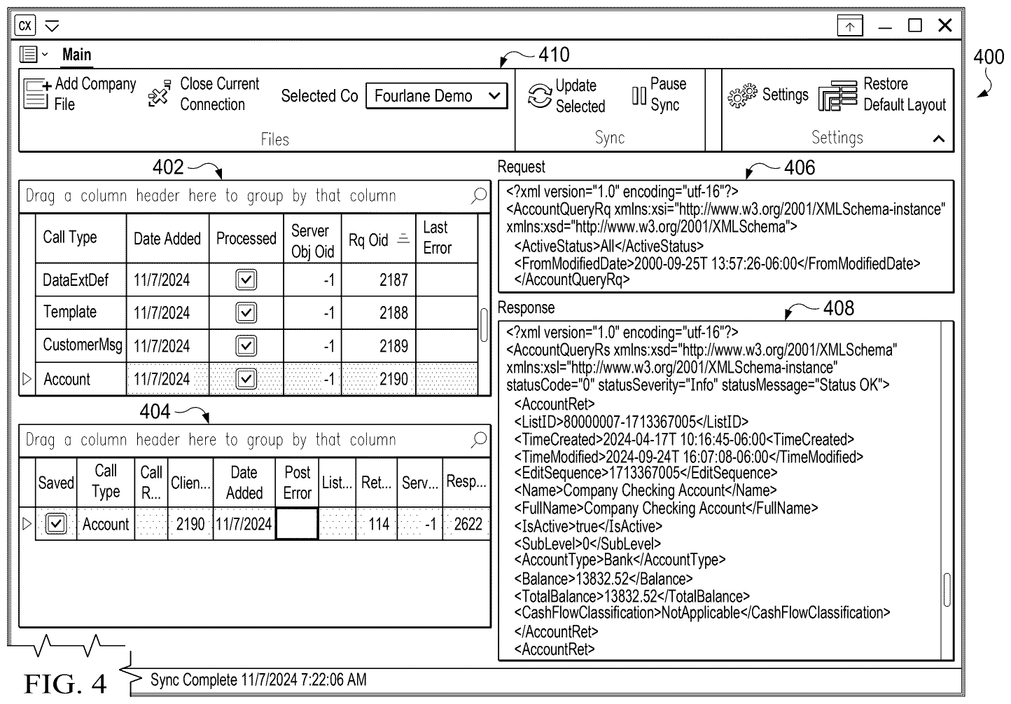

In some instances, once a user is authenticated, the user—interacting via a cloud application associated with the sync client 312B—can be provided a user identifier and a user interface (UI) presenting a particular desktop file to which they are connecting/interacting. The user identifier can indicate the particular file or files that are being synchronized FIG. 4 shows an example UI 400 of such an interaction. Users can see a log of connection activities to confirm that updates are being made between their cloud application with which they are interacting, and the desktop application on top of which the cloud application operates. As clients interact with the cloud application, updates are provided back to the desktop application via the sync client, and updates on the desktop's side are then provided back to the cloud service during the updates. The UI 400 includes four panes: a call request stack pane 402, a response pane 404, a request pane 406, and a response pane 408. The call request stack pane 402 shows pending and completed work packages at the sync client. The response pane 404 shows responses for the requests illustrated in 402. As illustrated, the response pane 404 can be filtered based on a selected request. The “account” request in 402 has been selected, and panes 404, 406, and 408 reflect that selection. Request pane 406 shows the unencrypted and decompressed request in XML, and 408 shows the response from the local desktop application before encryption and compression. The UI 400 can additionally include a toolbar 410, which contains various UI controls such as a “pause sync” button, settings button, and others.

As illustrated by 304 of FIG. 3, the cloud service determines the work to be done based on the last modified times. In one example, the last modified time is checked to determine whether a change or sync is needed. If the sync goes offline for any reason, when the sync client is reengaged, the solution will look first at the last modified time and determine changes that happened since that time. If changes are occurring at both the cloud application and the desktop application, the desktop application may have priority and determine the state of the system.

The sync client can request work over periods of time (e.g., every 10 seconds). The cloud service determines if an inbound sync of data is required. Any “Add” or “Modification” requests, for instance, can be immediately added to the stack. Record pointers back to the source records are included in the request so that once the data is returned, the source records are modified instead of being added again. The stack requests are then compressed and encrypted. Work is assigned on a “First Come, First Served” basis, meaning that if multiple sync clients are executing, only one sync client is given the work. Once the work has been assigned, the work will not then be reassigned.

In other words, once the initial information is provided, the user can interact with the data via their cloud application UI. Any actions that may cause a change to the cloud database are identified by the cloud service. That is, the sync client can receive information regarding interactions from the cloud application associated with cloud service. Additionally, new data and any changes to the desktop application are also identified and allow the data to be updated from the desktop to the cloud application—that is, synchronization is performed on both ends of the solution. In some instances, users may not need to perform an action to complete or pause their interaction for the changes to be made to the desktop application. Synchronization can occur even while users are operating in or interacting with either product.

As illustrated at 306, the sync client decompresses and decrypts requests, and processes them via the desktop application's SDK. The sync client then compresses and encrypts the results, along with any errors that occur during the request processing.

As illustrated at 308, the response data is then sent to the cloud service and stored in a processing cache. The data is not decrypted or decompressed but is saved in an encrypted or compressed format. The decryption, decompression, and writing to the database are queued until the synchronization is complete, thereby reducing the overall syncing time.

As illustrated at 310, after receiving the end of work signal, the web service initiates the process of decrypting, decompressing, and writing the results to the database. By waiting for the end of work signal to be sent, the sync client minimizes the time spent interacting with the desktop application's SDK, thus reducing or even preventing interference with other tasks.

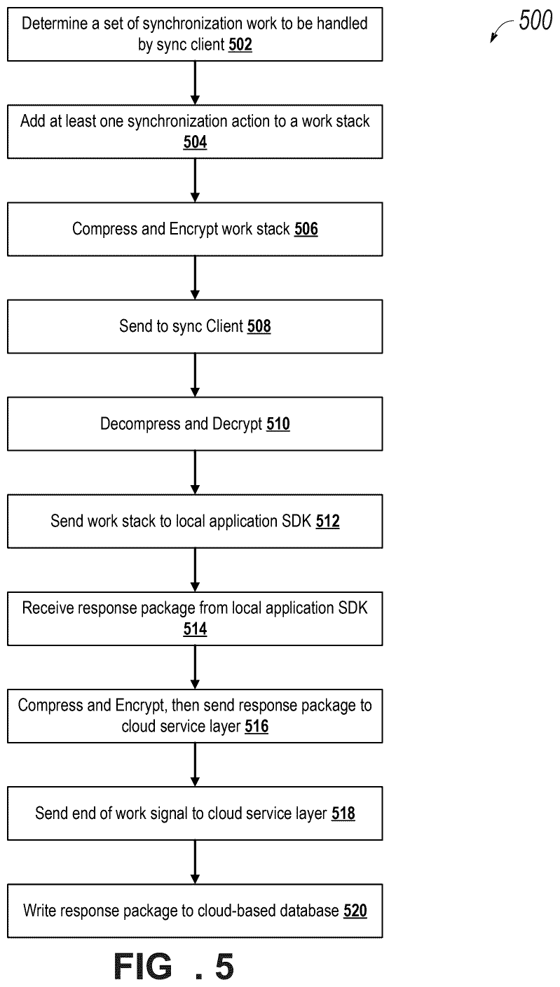

FIG. 5 is a flowchart illustrating an example process for synchronization. FIG. 5 is an example method illustrated from the point of view of a local computing system and cloud service layer, such as local computing system 102 and cloud service layer 104 of FIG. 1. However, it will be understood that process 500 may be performed, for example, by any other suitable system, environment, software, and hardware, or a combination of systems, environments, software, and hardware as appropriate. Process 500 may be performed by a plurality of connected components or systems. Any suitable system(s), architecture(s), or application(s) can be used to perform the illustrated operations.

At 502, a cloud service layer can determine a set of synchronization work to be handled by the sync client. The cloud service layer can be executing on a remote computing system, and the sync client executing on a local computing system. In some implementations the synchronization work is determined based on a last modified time of a cloud-based database. Synchronization work can include writing, reading, updating, deleting, or adding data to a cloud-based databased based on changes made in a local database.

At 504, the cloud service layer can add at least one synchronization action to a work stack to be handled by the sync client based on actions performed on the cloud-based database. In some implementations, the synchronization action includes at least one record pointer to source record. In some implementations, the synchronization action indicates up to 150 different database objects.

At 506, the work stack can be compressed and encrypted by the cloud service layer, and can then be transmitted, at 508, from the cloud service layer to the sync client.

At 510, the sync client can decompress and decrypt the work stack to put it in a format suitable for consumption by the local application.

At 512, the sync client can send the decompressed and decrypted work stack to an SDK of a local application. The SDK can then consume the work package and the local application can process the synchronization commands within.

At 514, the sync client can receive a response package from the SDK. The response package can be compressed and encrypted, and can then be sent back to the cloud service layer at 516.

At 516, an end of work signal is transmitted from the sync client to the cloud service layer, where the end of work signal indicates that the local application has completed the work stack and will not be returning any further work packages.

At 520, the cloud service layer can decompress and decrypt the response package and write results of the response package to the cloud-based database.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

While this specification contains many specific embodiment details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method comprising:
determining, at a cloud service layer executing on a remote computing system, a set of synchronization work to be handled by a sync client executing on a local computing system based on a last modified time of a cloud-based database;
adding, by the cloud service layer, at least one synchronization action to a work stack to be handled by the sync client based on actions performed on the cloud-based database, wherein the at least one synchronization action includes at least one record pointer to source records;
compressing and encrypting the work stack and transmitting the work stack from the cloud service layer to the sync client;
decompressing and decrypting, by the sync client, the work stack; and
sending, by the sync client, the decompressed and decrypted work stack to an SDK of a local application.

2. The method of claim 1, comprising:
receiving a response package from the SDK at the sync client;
compressing and encrypting the response package; and
transmitting the encrypted and compressed response package to the cloud service layer.

3. The method of claim 2, comprising:
transmitting an end of work signal from the sync client to the cloud service layer, wherein the end of work signal is different than the response package,
in response to receiving the end of work signal:
decompressing and decrypting, by the cloud service layer, the response package; and
writing results of the response package to the cloud-based database.

4. The method of claim 3, wherein the response package comprises at least one update to the cloud-based database based on a change to a database managed by the local application.

5. The method of claim 1, wherein the at least one synchronization action comprises an add request, or a modification request, to change a database managed by the local application in order to synchronize the database managed by the local application with the cloud-based database.

6. The method of claim 5, wherein the set of synchronization work comprises a parent synchronization action and a child synchronization action, wherein the child synchronization action is dependent on completion of the parent synchronization action, the method comprising:
adding, by the cloud service layer, the parent synchronization action to the work stack; and
responsive to receiving a response package indicating successful completion of the parent synchronization, queuing the child synchronization action to be added to a future work stack.

7. The method of claim 1, wherein transmitting the work stack from the cloud service layer to the sync client is scheduled to occur periodically at a predetermined interval.

8. The method of claim 7, wherein the predetermined interval is ten seconds.

9. The method of claim 1, wherein the local application is QuickBooks®.

10. A non-transitory, computer-readable medium storing one or more instructions executable by a computer system to perform operations comprising:
determining, at a cloud service layer executing on a remote computing system, a set of synchronization work to be handled by a sync client executing on a local computing system based on a last modified time of a cloud-based database;
adding, by the cloud service layer, at least one synchronization action to a work stack to be handled by the sync client based on actions performed on the cloud-based database, wherein the at least one synchronization action includes at least one record pointer to source records;
compressing and encrypting the work stack and transmitting the work stack from the cloud service layer to the sync client;
decompressing and decrypting, by the sync client, the work stack; and
sending, by the sync client, the decompressed and decrypted work stack to an SDK of a local application.

11. The medium of claim 10, the operations comprising:
receiving a response package from the SDK at the sync client;
compressing and encrypting the response package; and
transmitting the encrypted and compressed response package to the cloud service layer.

12. The medium of claim 11, the operations comprising:
transmitting an end of work signal from the sync client to the cloud service layer, wherein the end of work signal is different than the response package,
in response to receiving the end of work signal:
decompressing and decrypting, by the cloud service layer, the response package; and
writing results of the response package to the cloud-based database.

13. The medium of claim 12, wherein the response package comprises at least one update to the cloud-based database based on a change to a database managed by the local application.

14. The medium of claim 10, wherein the at least one synchronization action comprises an add request, or a modification request, to change a database managed by the local application in order to synchronize the database managed by the local application with the cloud-based database.

15. The medium of claim 14, wherein the set of synchronization work comprises a parent synchronization action and a child synchronization action, wherein the child synchronization action is dependent on completion of the parent synchronization action, the operations comprising:
adding, by the cloud service layer, the parent synchronization action to the work stack; and
responsive to receiving a response package indicating successful completion of the parent synchronization, queuing the child synchronization action to be added to a future work stack.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
determining, at a cloud service layer executing on a remote computing system, a set of synchronization work to be handled by a sync client executing on a local computing system based on a last modified time of a cloud-based database;
adding, by the cloud service layer, at least one synchronization action to a work stack to be handled by the sync client based on actions performed on the cloud-based database, wherein the at least one synchronization action includes at least one record pointer to source records;
compressing and encrypting the work stack and transmitting the work stack from the cloud service layer to the sync client;
decompressing and decrypting, by the sync client, the work stack; and
sending, by the sync client, the decompressed and decrypted work stack to an SDK of a local application.

17. The system of claim 16, the operations comprising:
receiving a response package from the SDK at the sync client;
compressing and encrypting the response package; and
transmitting the encrypted and compressed response package to the cloud service layer.

18. The system of claim 17, the operations comprising:
transmitting an end of work signal from the sync client to the cloud service layer, wherein the end of work signal is different than the response package,
in response to receiving the end of work signal:
decompressing and decrypting, by the cloud service layer, the response package; and
writing results of the response package to the cloud-based database.

19. The system of claim 18, wherein the response package comprises at least one update to the cloud-based database based on a change to a database managed by the local application.

20. The system of claim 16, wherein the at least one synchronization action comprises an add request, or a modification request, to change a database managed by the local application in order to synchronize the database managed by the local application with the cloud-based database.
